(19) United States
(12) Patent Application Publication
(10) Pub. No.: US 2005/0223525 A1
(43) Pub. Date: Oct. 13, 2005

(54) Pencil holder

(75) Inventors: Tony D. Wartian, Roseville, MI (US); Edward J. Strzelecki, Oxford, MI (US)

Correspondence Address: REISING, ETHINGTON, BARNES, KISSELLE, P.C., P O BOX 4390, TROY, MI, 48099-4390, US

(73) Assignee: Gotta Have Products

(21) Appl. No.: 11/145,756

(22) Filed: Jun. 6, 2005

Related U.S. Application Data
(63) Continuation-in-part of application No. 10/723,544, filed on Nov. 26, 2003.

(51) Int. Cl. B43K 25/00; A44B 21/00

(52) U.S. Cl. 24/3.12; 24/336

(57) ABSTRACT

A clip is adapted to attach a pencil or the like to a wearer's cap. The clip is made of a flexible resilient material. The clip has a first channel adapted to receive a lower edge portion of a wearer's cap. The clip also has a slot which is adapted to receive a pencil to be gripped between the sides of the slot. A tongue forms one side of the slot. A brace supports the tongue. Preferably a magnet is attached to the clip to magnetically hold an object such as a golf ball marker.

### REFERENCE TO RELATED APPLICATION

This application is a Continuation-In-Part of U.S. Ser. No. 10/723,544 filed on Nov. 26, 2003.

### FIELD OF THE INVENTION

This invention relates generally to pencil holders and more particularly to a pencil-holding clip for attaching a pencil to a wearer's cap.

### BACKGROUND OF THE INVENTION

Workers usually keep pencils and like writing implements in a pocket when they are not being used. However, a pocket is not the most convenient place to store a pencil, especially for people working outside on a job such as a construction site, for example. People engaged in athletic activities, such, for example, as golf, also have a need to carry a pencil.

### SUMMARY OF THE INVENTION

The clip of the present invention is adapted to attach a pencil or the like to a wearer's cap. The clip is made of a flexible resilient material. The clip has a first channel adapted to receive a lower edge portion of a wearer's cap. The strip also has a slot which is adapted to receive a pencil to be gripped between the sides of the slot.

More particularly, the strip has a base, a first leg extending upwardly from an inner end of the base and a second leg extending upwardly from an outer end of the base. The strip has a third leg extending upwardly between the first and second legs. The first and third legs cooperate with a first portion of the base to provide a first generally U-shaped, upwardly opening channel. The second and third legs cooperate with a second portion of the base to provide a second upwardly opening channel. The strip has a tongue extending from a return-bend of inverted, generally U-shape at an upper extremity of the second leg, downwardly into the second channel. The third leg and the tongue cooperate to provide a generally V-shaped, upwardly opening slot. The first channel is adapted to receive and grip a lower edge portion of the wearer's cap. The slot is adapted to receive a pencil to be gripped between the third leg and the tongue.

Preferably, a brace is provided between the second leg and the tongue to serve as a prop and relieve the return-bend from repeated flexing when the pencil is inserted and removed from the slot.

The clip may also have a retainer, such as a magnet, for retaining an object, for example, a golf ball marker.

One object of this invention is to provide a pencil-holding clip having one or more of the foregoing features and capabilities.

Other objects, features and advantages of the invention will become more apparent as the following description proceeds.

### BRIEF DESCRIPTION OF THE DRAWINGS

FIG. 1 is a perspective view showing a clip constructed in accordance with this invention attached to a wearer's cap, and a pencil attached to the clip;

FIG. 2 is a perspective view of the clip;

FIG. 3 is a front view of the clip;

FIG. 4 is a view similar to FIG. 3 but shows the lower edge portion of the cap gripped in a channel of the clip, and the pencil gripped in a slot of the clip;

FIG. 5 is a perspective view of a clip of modified construction;

FIG. 6 is a front view on the chip shown in FIG. 5; and

FIG. 7 is a sectional view taken on the line 7-7 in FIG. 6.

### DETAILED DESCRIPTION OF THE PREFERRED EMBODIMENTS

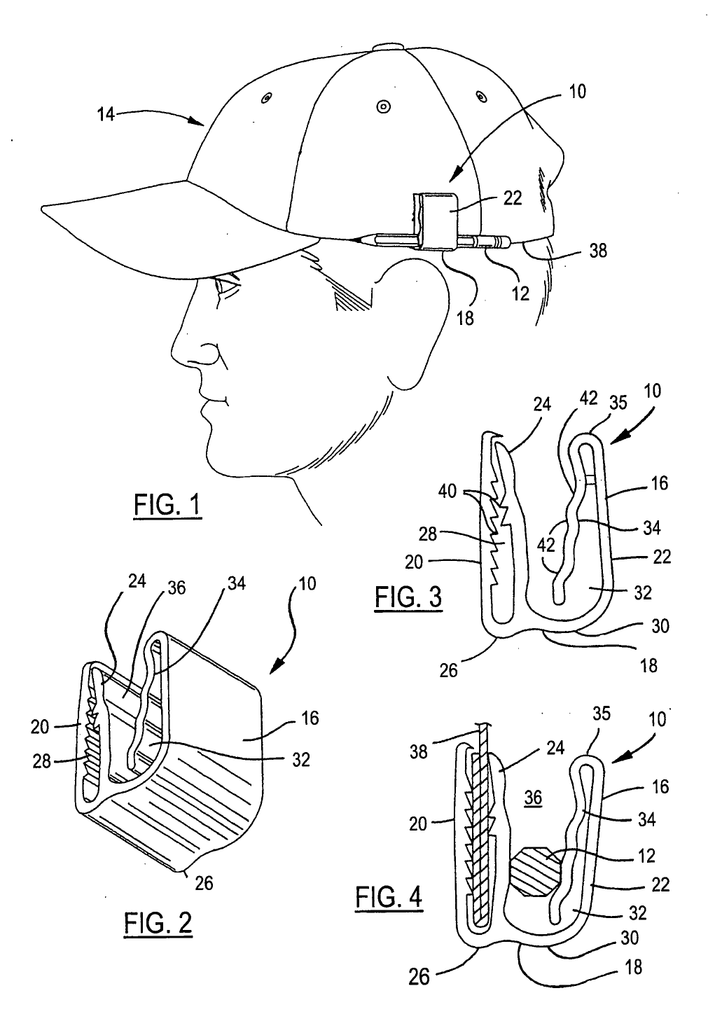

Now referring more particularly to the drawings, and especially FIGS. 1-4, there is shown a pencil-holding clip 10 for attaching a pencil 12 or similar writing implement to a cap 14. In FIG. 1 the cap 14 is shown being worn on the head of an individual.

Referring more particularly to FIGS. 2-4, the pencil-holding clip 10 is made of a strip 16 of flexible resilient material, preferably a suitable plastic. The strip 16 has a base 18. The strip 16 is turned upwardly at an inner end of the base 18 to provide a first upwardly extending leg 20. The strip 16 is turned upwardly at an outer end of the base 18 to provide a second upwardly extending leg 22 spaced from the leg 20. The strip has a third leg 24 extending upwardly from the base 18 between and spaced from the first and second legs 20 and 22.

The first and third legs 20 and 24 cooperate with a first portion 26 of the base to provide a first generally U-shaped, upwardly opening channel 28. The second and third legs 22 and 24 cooperate with a second portion 30 of the base to provide a second upwardly opening channel 32.

The strip 16 has a tongue 34 extending from a return-bend 35 of inverted, generally U-shape at an upper extremity of the second leg 22 downwardly into the second channel 32 in spaced relation to the second and third legs 22 and 24. The third leg 24 and the tongue 34 cooperate to provide a generally V-shaped, upwardly opening, pencil-receiving slot 36.

The entire clip 10, including the strip 16, the base 18, the legs 20, 22 and 24, and the tongue 34 are of one-piece, integral construction and preferably made of a suitable flexible, resilient plastic material.

The first channel 28 is adapted to receive and grip a lower edge portion 38 of the cap 14. The slot 36 is adapted to receive the pencil 12 or any similar writing instrument, to be gripped between the third leg 24 and the tongue 34.

As shown in FIG. 1, the clip 10 is attached to the cap 14 by inserting the lower edge portion 38 of the cap 14 downwardly into the channel 28. In this position, the slot 36 is on the outer side of the cap 14 in a position to receive a pencil 12 pressed downwardly between the third leg 24 and the tongue 34 and to be gripped between the third leg 24 and tongue 34.

Preferably, one or both of the legs 20 and 24 have sharp edges or barbs 40 along there inner surfaces adapted to grip the material of the lower edge portion of the cap 14 and to prevent the clip 10 from accidentally becoming separated from the cap 14.

Preferably the tongue 34 is formed into a stepped configuration having a series of steps 42 which, in a direction toward the lower free end of the tongue 34, are disposed closer and closer to the leg 24 to make it convenient for pencils of different diameters to be gripped so that they will not accidentally fall out. Of course the pencil may be removed from the slot 36 very easily either by moving it in the direction of its length as shown in FIG. 1 or by lifting it upwardly.

The entire clip 10 is made of a flexible resilient material and is shown in its natural free state condition in FIGS. 2 and 3. The leg 24 may be flexed slightly away from the leg 20 when the lower edge portion of the cap 14 is inserted therein and then will flex back into a position tightly gripping the lower edge portion of the cap 14 between the legs 20 and 24. Likewise, the tongue 34 is flexibly and resiliently connected to the second leg 22 at the return-bend 35 at the upper extremity of the second leg 22 and can be flexed away from the third leg 24 when the pencil 12 is inserted therein. The pencil 12 is thus tightly gripped but not gripped so tightly that it can not be easily removed.

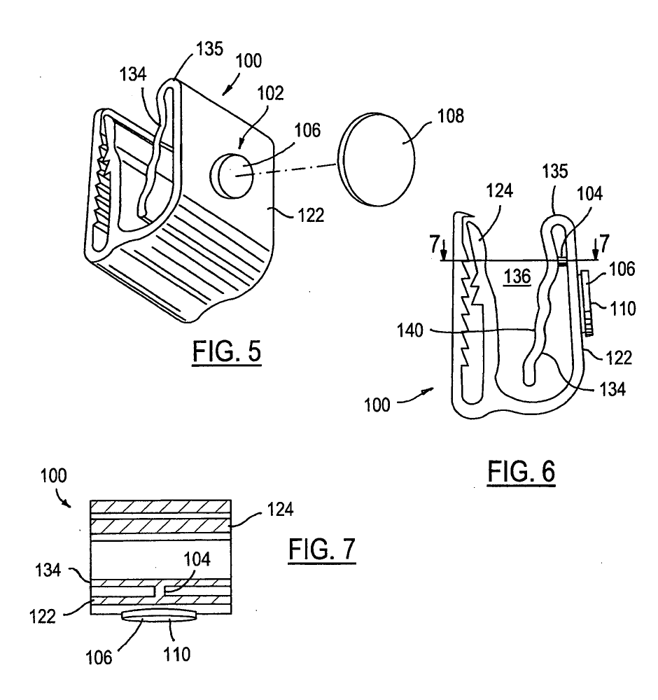

Referring to FIGS. 5-7, a further embodiment of the invention is shown in which the clip 100 is exactly like the clip 10 of the previous embodiment, but with the addition of a retainer in the form of a magnet 102 and a brace 104.

The magnet 102 is a piece of magnetic material glued or otherwise secured to an outer surface of the leg 122 approximately centrally of the leg. The magnet 102 is preferably in the form of a flat metallic plate 106 and is adapted to magnetically retain an object 108 which is shown as being in the shape of a small flat metal coin and which may be used by a golfer as a ball marker. The object 108 is adapted to be magnetically retained in surface-to-surface relation on the flat outer surface 110 of the magnetic plate 106.

The brace 104 is preferably in the form of a pin having one end secured to an inner surface of the leg 122 and an opposite end secured to an inner surface of the tongue 134. If the clip is made of a moldable material, the brace may be formed integrally with the leg 122 and with the tongue 134 in the molding process. Alternatively, the brace may be secured to only of the leg 122 and the tongue 134. The pin is closely spaced downwardly beneath the return-bend 135 at the upper extremity of the leg 122 where it connects into the upper extremity of the tongue so that the major portion 140 of the tongue beneath the brace can flex.

The purpose of the brace 104 is to serve as a prop and relieve the return-bend 135 from repeated flexing when a pencil is inserted and removed from the slot 136. When a pencil is inserted between the tongue 134 and the leg 122, only the portion 140 of the tongue beneath the brace flexes but this is sufficient to maintain a strong grip on the pencil. Without the brace 104, the return-bend 135 would have to flex each time a pencil is inserted or removed from the slot 136 between the tongue 134 and the leg. In time, the return-bend would weaken and the grip of the tongue on the pencil would be reduced.

1. A pencil-holding clip comprising:
a strip of flexible resilient material,
said strip having a base,
said strip being turned upwardly at an inner end of said base to provide a first upwardly extending leg,
said strip being turned upwardly at an outer end of said base to provide a second upwardly extending leg spaced from said first leg,
said strip having a third leg extending upwardly from said base between and spaced from said first and second legs,
said first and third legs cooperating with a first portion of said base to provide a first generally U-shaped, channel having an open upper end,
said second and third legs cooperating with a second portion of said base to provide a second upwardly opening channel,
said strip having a tongue extending from a return-bend at an upper extremity of said second leg downwardly into said second channel in spaced relation to said second and third legs,
said tongue having a resilient connection to said second leg at the outer extremity of the second leg,
said third leg and said tongue cooperating to provide a generally V-shaped, upwardly opening, pencil-receiving slot,
said first channel being adapted to receive and grip a lower edge portion of a wearer's cap,
said slot being adapted to receive a pencil and resiliently grip the pencil between said third leg and said tongue, and
a brace spaced downwardly from the return-bend and extending between said second leg and said tongue to serve as a prop for said tongue, said brace permitting a portion of the tongue downwardly beneath the brace to flex as necessary to maintain a grip on the pencil between the second leg and the tongue but protecting the return-bend from weakening as a result of flexing.

2. The pencil-holding clip of claim 1, wherein said brace is integrally attached to one of said tongue and said second leg.

3. The pencil-holding clip of claim 1, wherein said brace is in the form of a pin integrally secured to said tongue and to said second leg.

4. The pencil-holding clip of claim 4, further including a retainer secured to an outer surface of said second leg, said retainer being adapted to retain an object such as a golf ball marker.

5. The pencil-holding clip of claim 4, wherein said retainer comprises a magnet adapted to magnetically retain the object.

6. The pencil-holding clip of claim 5, wherein said brace is in the form of a pin integrally molded to said tongue and to said second leg.
